(19) United States
(12) Patent Application Publication
(10) Pub. No.: US 2020/0048148 A1
(43) Pub. Date: Feb. 13, 2020

(54) Efficient Formulation Stable Crude Glycerine Grinding Additive

(71) Applicant: GCP Applied Technologies Inc., Cambridge, MA (US)

(72) Inventors: Leslie AJ Buzzell, Burlington, MA (US); Dorota Kazmierczak, Acton, MA (US); Josephine H. Cheung, Lexington, MA (US)

(21) Appl. No.: 16/537,536

(22) Filed: Aug. 10, 2019

Related U.S. Application Data
(60) Provisional application No. 62/717,144, filed on Aug. 10, 2018.

(51) Int. Cl. C04B 24/02; C04B 7/52; C04B 24/08

(52) U.S. Cl. CPC C04B 24/02; C04B 2103/52; C04B 24/085; C04B 7/52

(57) ABSTRACT

Compositions and methods for grinding inorganic particles, such as cement, cement clinker, limestone, or other inorganic particles, involving a grinding efficiency enhancing additive comprising a crude glycerin byproduct, obtained through the use of heterogeneous catalyst processes in biodiesel fuel production. The molecules generated through the use of such heterogeneous catalytic processes result in a crude glycerin that confers good additive formulation stability, while avoiding or minimizing large quantities of undesirable compounds such as fatty acids, fatty acid esters, and salts.

### FIELD OF THE INVENTION

The invention relates to the field of grinding additives, and more particularly to a grinding additive comprising a byproduct obtained from biodiesel production using a heterogeneous catalytic process.

### BACKGROUND OF THE INVENTION

The manufacture of hydraulic cement, such as Portland cement, involves a grinding process that reduces clinker nodules into smaller particle sizes. At the beginning of this grinding operation, the clinker nodules have a generally spherical shape and consist of hydraulic calcium silicates, calcium aluminates, and calcium aluminoferrite. The clinker is mixed with small amounts of gypsum which is also ground into finely divided particles to produce the cement, which acts as a binder for making mortar and concrete.

As clinker grinding requires substantial time and energy, the cement industry typically employs grinding additives to increase efficiency of the operation. This lowers the power required to grind a unit of cement and otherwise increases cement output.

Addition of such grinding aids enables the mill to grind the clinker to a smaller size with less energy by prohibiting the buildup of a coating of finer material on the grinding media and/or walls of the grinding mill. This is accomplished by coating the nascent surfaces of the cement clinker,

Polyglycerols and “glycerins” have been known for use in cements and concrete. in U.S. Pat. No. 3,615,785, Moorer et al. disclosed the use of polyglycerols as additives for cement grinding, and preferred the use of di-, tri-, and tetra-glycerols, and mixtures thereof.

While the term “glycerol” is sometimes used interchangeably with “glycerin” (or “glycerine”), the present inventors will attempt to use the term “glycerin” to refer to the by-product obtained from biodiesel fuel production, a by-product which contains “glycerol” whose chemical definition is 1,2,3-propanetriol. The term glycerin is often used to refer to commercial products having glycerol content which could reach 95% or more.

Crude and waste glycerin materials are also known to be used in cement (See e.g., SU-1604773, SU-1271843, SU-1130548.). A crude polyglycerin derived from fossil fuel processing was used by W. R. Grace & Co.-Conn. in grinding aid additives in the 1980's.

Pat. Nos. 7,922,811, 8,979,998, and 9,328,021, owned by the common assignee hereof, disclose that crude glycerin can be obtained from biodiesel production, and combined with conventional cement additives including alkanolamine or glycols. The transesterification process used in creating biodiesel fuel also produces up to 15% chloride salt(s), water, and fatty acids and fatty acid esters in the crude glycerin byproduct.

Similarly, U.S. Pat. No. 7,887,630 taught that a “biodiesel manufacturing process by-product consisting of glycerin, mong, methanol, ethyl ester, inorganic salt and water” was useful for grinding solid inorganic materials.

WO 2006/051574 A2 taught that raw glycerin could be used as a cement strength enhancer. This raw glycerin, having 1-10% of alkali metal inorganic salt impurities, such as sodium chloride, was obtained as a by-product of a process wherein alkyl-esters and biodiesel are generated via transesterification of vegetable oils involving the use of a basic catalyst such as sodium hydroxide. The basic catalyst was neutralized with a mineral acid, such as hydrochloric acid, and this yielded an alkali metal inorganic salt (e.g., sodium chloride).

### SUMMARY OF THE INVENTION

The present invention departs from prior art biomass-derived grinding additives, and involves a novel grinding method and additive composition, wherein the grinding additive comprises crude glycerin obtained as a product from the production of biodiesel, using a heterogeneous catalytic process during esterification or transesterification of oils and fats into fatty acid esters (biodiesel).

The present inventors believe that heterogeneous catalytic processes may be used for generating crude glycerin byproducts, and that such byproducts would be highly useful for the grinding of cements or other inorganic materials. For example, U.S. Pat. No. 8,124,814, which concerns the manufacture of dichloropropanol, describes the use of an acidic heterogeneous catalytic process to generate an intermediate crude glycerin, such as glycerol alkyl ether. The present inventors believe these would be beneficial if used for the grinding manufacture of cement; and, more specifically, that glycerol monomethyl ethers comprising 3-methoxy-1,2-propanediol and/or 2-methoxy-1,3-propanediol would be of particular benefit in grinding operations.

The present inventors also note that the '814 patent describes reacting a vegetable fat or oil with an alcohol “under such conditions that ethers of glycerol are formed and are not separated from glycerol.” The present inventors also note that the '814 patent describes, along with use of acidic heterogeneous catalytic process(es), the presence of acidic compounds such as carboxylic acids in the fats or oils, the use of a high transesterification temperature, and long residence time of the alcohol/vegetable fat or oil mixture on the catalyst. Using heterogeneous catalytic processes under conditions as described in the '814 patent would, the present inventors believe, generate crude glycerin containing small polar molecules, such as glycerol ethers (e.g., methoxypropanediol (“MPD”)), suitable for grinding inorganic materials.

This approach is unexpected given that conventional processes for making fatty acid esters generally try to avoid MPD. For example, in U.S. Pat. No. 8,252,949, Seki et al describe a fatty acid ester manufacturing process, wherein “reaction temperature is . . . preferably 200° C. or less, from the viewpoint of inhibiting the formation of ethers between glycerin such as byproduct methoxypropanediol . . .”. Consequently, for the purpose of simplifying glycerin removal from the biodiesel production process, Seki et al teach that production of MPD is undesirable.

In addition to thwarting conventional wisdom by implementing heterogeneous-catalyst-produced glycerin byproduct having glycerol alkyl ethers (such as MPD or other alkoxypropanediols), the present inventors believe heterogeneous catalytic processes provide advantages for the crude glycerin thus derived.

The description by Hillion et al of a conventional homogeneous catalyst process for the production of biodiesel via transesterification of oils resulting in a glycerin byproduct, which appears to resemble the one described in U.S. Pat. No. 9,328,021, mentions that hydrochloric acids are used for catalyst recovery, resulting in formation of significant quantities of chloride salts, with glycerol purity as low as 80%. See Hillion et al., Biodiesel Production by a Continuous Process using a Heterogeneous Catalyst, Prepr. Pap.-Am. Chem. Soc., Div. Fuel Chem. 2003, 48(2), 638. This process could yield fatty acids (i.e., soaps) that, if present at levels up to 5% in the crude glycerin, could cause excessive air entrainment in concrete. High amounts of fatty acids would also float to the top of crude glycerin stored in bulk containers. On the other hand, Hillion et al describe that the heterogeneous catalytic processes do not require catalyst recovery. Without the use of sodium hydroxide catalyst, side reactions forming sodium soaps are avoided.

Hence, the present inventors believe that use of heterogeneous catalytic processes would not entail significant formation of chloride salts or foaming soap-like compounds. The present inventors therefore believe that heterogeneous catalytic processes provide benefits as compared to homogeneous catalytic processes with respect to generating crude glycerin for use in grinding.

The heterogeneous catalytic process described by Hillion et al involves a mixed oxide of zinc and aluminum. As such, the present inventors believe that crude glycerin production via heterogeneous catalytic processes would be substantially free of by-products (e.g., chloride salts or water) not considered beneficial to cement production. The crude glycerin produced by heterogeneous catalytic processes would be nearly free of fatty acids, fatty acid esters, and other byproducts that otherwise requiring purification, thus affording aqueous formulations of grinding additives some considerable mix design flexibility.

The term “heterogeneous catalytic process(es)” as used herein shall refer to glycerin obtained as a by-product from the manufacture of biodiesel using heterogeneous catalytic esterification as described by Singh Chouhan et al, who wrote: “If the catalyst remains in the same (liquid) phase [as] that of the reactants during transesterification, it is homogeneous catalytic transesterification”; whereas, on the other hand, “if the catalyst remains in different phase (i.e. solid, immiscible liquid or gaseous) [compared to] that of the reactants[,] the process is called heterogeneous catalytic transesterification.” Singh Chouhan et al. Modern heterogeneous catalysts for biodiesel production: A comprehensive review. Renewable and Sustainable Energy Reviews 15 (2011) 4378-4399. Most critical is the resulting absence of soaps, which can separate, chloride salts and water, which do not contribute to grinding, and the alternative presence of glycerol ethers, which enhance efficiency of particle grinding.

The present inventors believe that heterogeneous catalytic esterification or transesterification provides a “greener” technology. This is because (1) the catalyst can be recycled and reused, (2) relatively little or no waste water produced, and (3) glycerol removal from the biodiesel fuel production process is facilitated. In contrast, homogeneous catalytic esterification or transesterification produces a glycerin which, the present inventors believe, is of lower quality and requires extended distillation to remove impurities.

An exemplary method of the present invention for grinding inorganic particles, thus comprises:

(A) introducing a grinding additive composition into a plurality of particles to be ground to finer particle size in a ball mill or roller mill, the particles chosen from cement, clinker, calcite, limestone, aragonite, sea shells, marl, limonite, clay, shale, sand, bauxite, blast furnace slag, fly ash, natural pozzolan, calcium sulfate, or mixtures thereof;

(B) the grinding additive composition comprising a crude glycerin byproduct obtained using a heterogeneous catalytic process during biodiesel fuel production, the crude glycerin byproduct comprising: (i) 1,2,3-propanetriol in an amount of 50-99 percent; (ii) at least one glycerol ether (e.g., methoxypropanediol, or “MPD”) in an amount of 5-50 percent; and (iii) chloride salt, ash, fatty acid, and fatty acid ester in an amount of 0-1 percent, the foregoing percentages based on total weight of the crude glycerin generated by the heterogeneous catalytic process; and

(C) grinding together the grinding additive composition and plurality of particles in the ball mill or roller mill, whereby the particles are ground to finer particle size.

An exemplary additive composition for grinding an inorganic material in a ball mill or roller mill, comprises: a crude glycerin byproduct obtained using a heterogeneous catalytic process(es) process during biodiesel fuel production, the crude glycerin byproduct comprising: (i) 1,2,3-propanetriol in an amount of 50-99 percent; (ii) at least one glycerol ether (e.g., methoxypropanediol, ethoxypropanediol, etc.) in an amount of 5-50 percent; and (iii) chloride salt, ash, fatty acid, and fatty acid ester in an amount of zero to 1 percent, the foregoing percentages based on total weight of the crude glycerin obtained using a heterogeneous catalytic process.

Further advantages and features of the invention will be described in further detail hereinafter.

### BRIEF DESCRIPTION OF THE DRAWINGS

An appreciation of the benefits and features of the present invention may be more readily comprehended by considering the following written description of exemplary embodiments in conjunction with the drawings, wherein

FIG. 1 is graphic illustration of grinding performance of PRIOR ART crude glycerin compared to an exemplary crude glycerin of the present invention, in terms of achieving fineness (blaine) over time; and

FIG. 2 is a graphic illustration of grinding performance of PRIOR ART crude glycerin compared to an exemplary crude glycerin in accordance with the present invention, in terms of achieving fineness (passing through a 45 micron sieve) over time.

### DETAILED DESCRIPTION OF EXEMPLARY EMBODIMENTS

The present invention provides a method and composition useful for enhancing the grinding efficiency of inorganic particles, including but not limited to cement (e.g., Portland cement), clinker, calcite, limestone, aragonite, sea shells, marl, limonite, clay, shale, sand, bauxite, blast furnace slag, fly ash, natural pozzolan, calcium sulfate, and mixtures thereof.

The compositions and methods of the present invention may be used with or in conventional grinding mills, such as ball mills (or tube mills). The present inventors also believe that they can be applied in mills employing rollers (e.g., vertical roller mills which employ rollers on horizontal revolving tables). See e.g., U.S. Pat. No. 6,213,415 of Cheung.

The term “Portland cement” as used herein includes hydratable cement which is produced by pulverizing clinker consisting of hydraulic calcium silicates and one or more forms of calcium sulfate (e.g., gypsum) as an interground additive.

The term “cementitious” as used herein refers to materials that comprise Portland cement or which otherwise function as a binder to hold together fine aggregates (e.g., sand), coarse aggregates (e.g., crushed gravel), or mixtures thereof. The term cementitious can refer to mixtures of Portland cement with other inorganic particles, including those identified at the beginning of this section.

The present invention provides a method and composition useful for enhancing the grinding efficiency of cement, clinker, calcite, limestone, aragonite, sea shells, marl, limonite, clay, shale, sand, bauxite, blast furnace slag, fly ash, natural pozzolan, calcium sulfate, or mixtures thereof. In particular, the inventors believe that the present invention will provide effective grinding of cementitious materials such as Portland cement, fly ash, granulated blast furnace slag, limestone, natural pozzolans, as well as mixtures thereof. Typically, Portland cement is combined with one or more other cementitious materials and provided as a blend. The method and composition of the invention, however, can be used separately for grinding Portland cement, or any of the other inorganic materials identified above, independently or in any combination.

The term “hydratable” as used herein is intended to refer to cement or cementitious materials that are hardened by chemical interaction with water. Portland cement clinker is a partially fused mass primarily composed of hydratable calcium silicates. The calcium silicates are essentially a mixture of tricalcium silicate (3CaO.SiO₂ “C₃S” in cement chemists’ notation) and dicalcium silicate (2CaO.SiO₂, “C₂S”) in which the former is the dominant form, with lesser amounts of tricalcium aluminate (3CaO.Al₂O₃, “C₃A”) and tetracalcium aluminoferrite (4CaO.Al₂O₃.Fe₂O₃, “C₄AF”). See e.g., Dodson, Vance H., Concrete Admixtures (Van Nostrand Reinhold, New York N.Y. 1990), page 1.

The phrases “heterogeneous catalytic process(es)” and “glycerin obtained using heterogeneous catalytic process(es)” as used herein will be the same as that provided by Singh Chouhan et al, which was described in the summary section above: namely, glycerin obtained as a by-product from the manufacture of biodiesel using heterogeneous catalytic esterification or transesterification (of fats and oils), where, in contrast to homogeneous catalytic transesterification wherein the catalyst remains in the same (liquid) phase as that of the reactants, the catalyst remains in a different phase (i.e. solid, immiscible liquid, or gaseous) phase compared to the reactants. Singh Chouhan et al. Modern heterogeneous catalysts for biodiesel production: A comprehensive review. Renewable and Sustainable Energy Reviews 15 (2011) 4378-4399.

It is envisioned that my different types of materials can be used as heterogenous catalysts in the production of biodiesel fuel. Examples of catalysts may be found in any number of three references.

For example, Singh Chouhan et. al. report that that calcium oxide (CaO) is widely used in transesterification, with high reported yields (98%), although re-usability is low). Id. Modification of CaO to organo metallic natures, e.g. Ca(OCH₃), Ca(C₃H₇O₃)₂ has been found to be very effective with respect to reusability, with acceptable yields (92%).

As another example, Endalew et al. reported in Heterogeneous Catalysis for Biodiesel Production from Jatropha Curcas Oil (JCO), Energy 36 (2011) 2693-2700, that preferred heterogeneous catalytic process(es) for biodiesel production are blends of CaO+Fe₂(SO₄)₃ and Li-CaO+Fe₂(SO₄)₃.

Finally, U.S. Pat. No. 8,124,801 reports the use of catalyst molybdenum salt or molybdenum oxide with promoter phosphorus.

In a first example embodiment, the invention provides a method for grinding particles, comprising:

(A) introducing a grinding additive composition into a plurality of particles to be ground to finer particle size in a ball mill or roller mill, the particles chosen from cement, clinker, calcite, limestone, aragonite, sea shells, marl, limonite, clay, shale, sand, bauxite, blast furnace slag, fly ash, natural pozzolan, calcium sulfate, or mixtures thereof;

(B) the grinding additive composition comprising a crude glycerin byproduct obtained using a heterogeneous catalytic process during biodiesel fuel production, the crude glycerin byproduct comprising: (i) 1,2,3-propanetriol in an amount of 50-99 percent; (ii) at least one glycerol ether in an amount of 5-50 percent; and (iii) chloride salt, ash, fatty acid, and fatty acid ester in an amount of 0-1 percent, the foregoing percentages based on total weight of the crude glycerin generated by the heterogeneous catalytic process; and

(C) grinding together the grinding additive composition and plurality of particles in the ball mill or roller mill, whereby the particles are ground to finer particle size.

In a first aspect of the first example embodiment, the glycerol ether is more preferably present in the amount of 10-45%, and most preferably in the amount of 15-40%, based on the total weight of the crude glycerin generated by the heterogeneous catalytic process.

In a second example embodiment, which may be based on the first example embodiment described above, the at least one glycerol ether is chosen from methoxypropanediol, ethoxypropanediol, propoxypropanediol, butoxypropanediol or a mixture thereof. For example, the glycerol ether can be an ethoxypropanediol, such as 3-Ethoxy-1,2-propanediol (CAS 1874-62-0), a propoxypropanediol, such as 3-propoxy-1,2-propanediol (CAS 61940-71-4); or a butoxypropanediols such as 3-Butoxy-1,2-propanediol (CAS 624-52-2).

In a third example embodiment, which may be based on the first through second example embodiment above, the at least one glycerol ether is chosen from 3-methoxy-1,2-propanediol, 2-methoxy-1,3-propanediol, or mixture thereof.

In a fourth example embodiment, which may be based on the third example embodiment above, the at least one glycerol ether comprises both both 3-methoxy-1,2-propanediol and 2-methoxy-1,3-propanediol, wherein the ratio of 3-methoxy-1,2-propanediol to 2-methoxy-1,3-propanediol is 6:1 to 3:1.

In a first aspect of the fourth example embodiment, a more preferred ratio of 3-methoxy-1,2-propanediol to 2-methoxy-1,3-propanediol is 4:1.

In a fifth example embodiment, which may be based on any of the first through fourth example embodiments above, the method involves grinding the particles using a crude glycerin obtained through heterogeneous catalyst process wherein the crude glycerin contains MPD in the amount of 10%-30% by weight based on total weight of crude glycerin through heterogeneous catalyst process.

In a sixth example embodiment, which may be based on any of the first through fourth example embodiments above, the method involves grinding the particles using a crude glycerin obtained through heterogeneous catalyst process wherein the crude glycerin contains zero to less than 0.5% fatty acids, fatty acid esters, or oil, based on total weight of the crude glycerin.

In a seventh example embodiment, which may be based on any of the first through sixth example embodiments above, the method involves grinding the particles using a grinding additive composition comprising crude glycerin obtained through heterogeneous catalyst process, wherein the grinding additive composition comprises water.

In a first aspect of the seventh example embodiment, the grinding additive composition preferably comprises 5-70% water based on total weight of the additive composition, and more preferably comprises 10-30% water based on total weight of the additive composition.

In an eighth example embodiment, which may be based on any of the first through seventh example embodiments above, the method further comprises grinding the inorganic particles with a conventional additive chosen from triethanolamine, triisopropanolamine, diethanolisopropanolamine, tetrahyroxyethyl-ethylene diamine, ethanoldiisopropanolamine, diethanolamine, methoxydiethanol-amine, ethoxylated methoxydiethanolamine, a glycol, a crude glycerin obtained from a homogeneous catalyzed process, an acetic acid or salt thereof (e.g., sodium acetate, potassium acetate), or mixtures thereof.

In a first aspect of the eighth example embodiment, the method further comprises grinding the inorganic particles with a glycol chosen from monoethylene glycol, diethylene glycol, triethylene glycol, polyethylene glycol, propylene glycol, dipropylene glycol tripropylene glycol, polypropylene glycol, and mixtures thereof.

In a second aspect of the eighth example embodiment, the additive composition further comprises a defoaming agent. For example, the defoaming agent is triisobutylphosphate, or ethoxylated, propoxylated fatty alcohol or alkylphenol.

In a ninth example embodiment, which may be based on any of the first through eighth example embodiments above, the method further comprises grinding the inorganic particles with N-(2-hydroxyethyl)iminodiacetic acid (EDG), N-(2-hydroxypropyl)iminodiacetic acid (IPDG), or salt thereof. These components may be pre-blended into the additive composition, or used independently, or added before, during, or after the additive composition comprising the crude glycerin is introduced to the inorganic particles being ground. Preferably, these components are pre-blended into the additive composition, such that the components and crude glycerin can be introduced into the grinding operation as a single (preferably liquid pumpable) component.

In a tenth example embodiment, which may be based on any of the first through ninth example embodiments above, the additive composition has a pH which is greater than 8.0.

In a first aspect of the tenth example embodiment, the additive composition has a pH which is greater than 10.0.

In an eleventh example embodiment, which may be based on any of the first through tenth example embodiments above, the additive composition further includes or is combined with at least one conventional grinding additive (e.g., particularly as listed in the eighth example embodiment), and the amount of grinding additives to the amount of crude glycerin byproduct obtained from the manufacture of biodiesel using a heterogeneous catalyzed process is 90:10 to 10:90 based on relative weight of the additives and crude glycerin byproduct.

In a twelfth example embodiment, which may be based on any of the first through eleventh example embodiments above, the method involves introducing the additive composition to cement clinker particles at a dosage rate of 0.01% to 0.1% dry weight of cement clinker particles.

In a thirteenth example embodiment, the present invention provides an additive composition for grinding inorganic particles, comprising: crude glycerol byproduct obtained using a heterogeneous catalytic process during biodiesel fuel production, the crude glycerin byproduct comprising: (i) 1,2,3-propanetriol in an amount of 50-99 percent; (ii) at least one glycerol ether in an amount of 5-50 percent; and (iii) chloride salt, ash, fatty acid, and fatty acid ester in an amount of 0-1 percent, the foregoing percentages based on total weight of the crude glycerin generated by the heterogeneous catalytic process.

In a fourteenth example embodiment, which may be based on the thirteenth example embodiment above, the additive composition comprises at least one glycerol ether is chosen from methoxypropanediol, ethoxypropanediol, propoxypropanediol, butoxypropanediol, or a mixture thereof. For example, the at least one glycerol ether can be methoxypropanediol; or an ethoxypropanediol, such as 3-Ethoxy-1,2-propanediol (CAS 1874-62-0); a propoxypropanediol, such as 3-propoxy-1,2-propanediol (CAS 61940-71-4); or a butoxypropanediol, such as 3-Butoxy-1,2-propanediol (CAS 624-52-2).

In a fifteenth example embodiment, which may be based on the thirteenth through fourteenth example embodiment above, the additive composition comprises a methoxypropanediol chosen from 3-methoxy-1,2-propanediol, 2-methoxy-1,3-propanediol, or mixture thereof.

In a sixteenth example embodiment, which may be based on the thirteenth through fifteenth example embodiments above, the additive composition comprises a mixture of 3-methoxy-1,2-propanediol and 2-methoxy-1,3-propanediol, wherein the ratio of 3-methoxy-1,2-propanediol to 2-methoxy-1,3-propanediol is 6:1 to 3:1.

In a first aspect of the sixteenth example embodiment, the ratio of 3-methoxy-1,2-propanediol to 2-methoxy-1,3-propanediol is more preferably 4:1.

In a seventeenth example embodiment, which may be based on the thirteenth through sixteenth example embodiments above, the crude glycerin obtained from the manufacture of biodiesel using a heterogeneous catalyzed process comprises at least one methoxypropanediol in the amount of 10%-30% based on total weight of crude glycerin obtained from the manufacture of biodiesel using a heterogeneous catalyzed process.

In an eighteenth example embodiment, which may be based on the thirteenth through seventeenth example embodiments above, the additive composition comprises a crude glycerin obtained through heterogeneous catalyst process which contains fatty acids, fatty acid esters, or oil in an amount of zero to less than 0.5% based on total weight of the crude glycerin.

In a nineteenth example embodiment, which may be based on the thirteenth through eighteenth example embodiments above, the additive composition further comprises water.

In a first aspect of the nineteenth example embodiment, the additive composition comprises water in the amount of 5-70 percent based on total weight of the additive composition.

In a second aspect of the nineteenth example embodiment, the additive composition more preferably comprises water in the amount of 10-30 percent based on total weight of the additive composition.

In a twentieth example embodiment, which may be based on the thirteenth through nineteenth example embodiments above, the additive composition further comprises at least one conventional cement additive chosen from triethanolamine, triisopropanolamine, diethanolisopropanolamine, tetrahyroxyethylthylene diamine, ethanoldiisopropanolamine, diethanolamine, methoxydiethanolamine, ethoxylated methoxydiethanolamine, a glycol, crude glycerin from a homogeneous catalyzed process, an acetic acid or salt thereof, or mixtures thereof.

In a first aspect of the twentieth example embodiment, the conventional cement additive is a glycol chosen from monoethylene glycol, diethylene glycol, triethylene glycol, polyethylene glycol, propylene glycol, dipropylene glycol tripropylene glycol, polypropylene glycol, and mixtures thereof.

In a second aspect of the twentieth example embodiment, the additive composition further comprises a defoaming agent. A preferred defoaming agent is triisobutylphosphate.

In a twenty-first example embodiment, which may be based on the thirteenth through twentieth example embodiments above, the additive composition further comprises N-(2-hydroxyethyl)iminodiacetic acid (EDG), N-(2-hydroxypropyl)iminodiacetic acid (IPDG) or salt thereof, or mixtures thereof.

In a twenty-second example embodiment, which may be based on the thirteenth through twenty-first example embodiments above, the additive composition has a pH greater than 8.0.

In a first aspect of the twenty-second example embodiment, the additive composition more preferably has a pH greater than 10.0.

In a twenty-third example embodiment, which may be based on the thirteenth through twenty-second example embodiments above, the additive composition further comprises a cement additive (which may be chosen particularly form the twentieth and twenty first example embodiments above) wherein the ratio of the one or more cement additives to the crude glycerin byproduct obtained from manufacture of biodiesel using a heterogeneous catalyzed process is 90:10 to 10:90 by weight.

While the invention is described herein using a limited number of embodiments, these specific embodiments are not intended to limit the scope of the invention as otherwise described and claimed herein. Modification and variations from the described embodiments exist. More specifically, the following examples are given as a specific illustration of embodiments of the claimed invention. It should be understood that the invention is not limited to the specific details set forth in the examples. All parts and percentages in the examples, as well as in the remainder of the specification, are by percentage weight unless otherwise specified.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k*(RU -RL), where k is a variable ranging from 1% to 100% with a 1% increment, e.g., k is 1%, 2%, 3%, 4%, 5% . . . . 50%, 51%, 52% . . . 95%, 96%, 97%, 98%, 99%, or 100%. Moreover, any numerical range represented by any two values of R, as calculated above, is also specifically disclosed.

### Exemplifications

### EXAMPLE 1

Cements were prepared in a laboratory ball mill with the following material proportions, as shown in Table 1:

TABLE 1

| Component | Weight (grams) |
|---|---|
| Clinker weight (g) | 3395 |
| Gypsum(g) | 110 |
| Plaster (g) | 78 |

The following additives were used: Crude glycerin obtained from biodiesel fuel production using a homogeneous catalyzed process (hereinafter designated “HOM”), as identified in Table 2:

TABLE 2

| Component | Percent |
|---|---|
| Glycerol | 84% |
| Fatty acids | 0.75% |
| methanol | 0.06% |
| NaCl | 4% |
| water | 12% |

Crude glycerin Crude glycerin obtained from biodiesel fuel production using a heterogeneous catalyzed process (hereinafter designated “HET”), as identified in Table 3:

TABLE 3

| Component | Percent |
|---|---|
| glycerol | 76.2% |
| fatty acids | 0.01% |
| methanol | 0.28% |
| 3-methoxy-1,2-propanediol | 16% |
| 2-methoxy-1,3-propanediol | 4% |
| water | 3.2% |

The fatty acids in the HET crude glycerin at 0.01% are significantly lower than the fatty acids in good quality HOM crude glycerin, controlled at 0.75%. This good quality HOM crude glycerin is believe to be from a homogeneously catalyzed process. Levels of methoxypropanediols are expected to range from 10% to 30% in the HET crude glycerin, in a 4:1 ratio (3-methoxy-1,2-propanediol: 2-methoxy-1,3-propanediol).

Also tested were 75:25 blends of diethylene glycol with each kind of crude glycerin.

Additives were introduced with the clinker, gypsum, and plaster. Blaine and Alpine fineness were measured at 90, 120, and 150 minutes, as shown in Table 4:

TABLE 4

| | | Blaine cm²/gram | | | Alpine % passing 45 micron | | |
|---|---|---|---|---|---|---|---|
| | | at time in minutes | | | at time in minutes | | |
| Additives | ppm | 90 | 120 | 150 | 90 | 120 | 150 |
| HOM Crude glycerin | 300 | 2752 | 3062 | 4587 | 89.7 | 93.3 | 95.4 |
| HET Crude glycerin | 300 | 2849 | 3314 | 4692 | 91.6 | 95.0 | 96.1 |
| Glycol/HOM crude glycerin 75:25 | 300 | 2912 | 4437 | 4778 | 96.1 | 97.9 | 98.3 |
| Glycol/HET crude glycerin 75:25 | 300 | 2949 | 4493 | 5001 | 95.3 | 98.4 | 98.5 |
| No additive | -0- | 2081 | 2297 | 3416 | 78.7 | 86.7 | 90.6 |
| Glycol (Diethylene glycol) | 300 | 2968 | 4747 | 5310 | 94.0 | 97.5 | 98.9 |

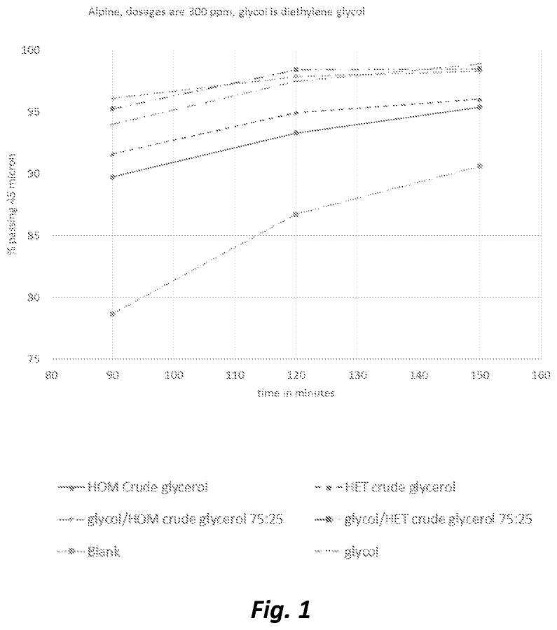

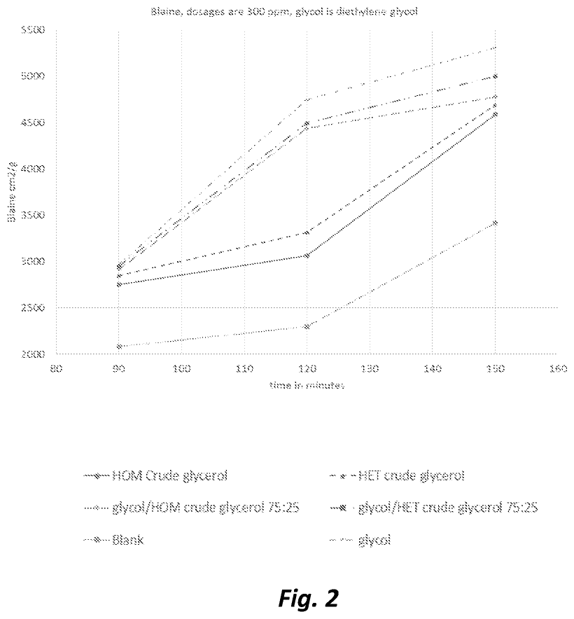

At each time interval, as measured by Alpine fineness, cements prepared with the HET crude glycerin were finer than cements prepared with the HOM crude glycerin. See FIGS. 1. At 120 and 150 minutes, as measured by Blaine fineness, cements prepared with the HET crude glycerin were finer than cements prepared with the HOM crude glycerin. See FIG. 2.

### EXAMPLE 2

The HET crude glycerin described in the first example has a green tinge, which is undesirable, in that it is different from most cement additive compositions. The pH of a 70% aqueous solution HET crude glycerin was measured at 3.95. Upon addition of 0.03% potassium hydroxide, raising the solution pH to 9.12, the solution turns a purplish color. Upon addition of an additional 0.03% potassium hydroxide, raising the solution pH to 10.76, the solution turns a desirable brown color. Possible known heterogeneous catalytic processes that could form a green color would likely involve the use of iron, molybdenum, or nickel based catalysts. Iron based catalysts are described by Lee et al., Heterogeneous Catalysis for Sustainable Biodiesel Production via Esterification and Transesterification, Chem. Soc. Rev., 2014, 43, 7887-7916] and Endalew et al., Heterogeneous Catalysis for Biodiesel Production from Jatropha Curcas Oil (JCO), Energy 36 (2011) 2693-2700. While heterogeneous catalytic processes are expected to involve the catalyst remaining in a different phase compared to the reactants, the present inventors believe that small amounts of iron, molybdenum, or nickel ions could remain with the crude glycerin and be solubilized at acidic pH. The present inventors conducted analysis via inductively coupled plasma (ICP) spectrometry of HET crude glycerin, confirming the presence of 27 ppm iron, 57 ppm molybdenum, and ˜1 ppm nickel.

Fe (II) is a green color. With increasing pH Fe (II) is oxidized to form insoluble Fe (III) hydroxide. As pH of HET glycerin solution was increased from pH 3.95 to 10.76, the present inventors speculate that Fe(II) (green color in aqueous solution) oxidizes into Fe (III) hydroxide (not water-soluble, slightly brownish color).

Stark reports that Mo(III) is green in color. The color turns to brown and then red brown at higher oxidation states. Stark, J. K. The Oxidation States of Molybdenum. J. Chem. Educ., 1969, 46 (8), p 505. As the pH of the HET glycerin solution was increased from pH 3.95 to 10.76, it is believed by the present inventors that 57 ppm Mo (III) changed to a higher oxidation state, eliminating a cause for the green color.

Ni (II) is a green color. The present inventors suspect that, with increasing pH, Ni (II) could be forming an insoluble Ni (II) hydroxide, as suggested by Demidov, which precipitates out of solution. Alternatively, with increasing pH, Ni (III) was likely formed (due to loss of green color). See Demidov, A. I. & Volkova, E. N. Russ J Appl Chem (2009) 82: 1498, for potential-pH diagram for the nickel-water system containing nickel(III) metahydroxide. Although the present inventors discovered nickel in the HET crude glycerin sample tested, the amount was small, and thus they suspect that nickel was not the catalyst giving rise to the green color.

### EXAMPLE 3

An example additive composition in accordance with the present invention, with pH 9.41, having a desirable brown color, was formulated using the following components, as shown in Table 5:

TABLE 5

| Component | Percent |
|---|---|
| Triisopropanolamine | 20.70% |
| Water | 19.20% |
| Triisobutylphosphate | 0.80% |
| Diethylene Glycol | 4.60% |
| HET crude glycerin | 54.70% |

### EXAMPLE 4

An example additive composition in accordance with the present invention, with pH 10.15 and a desirable brown color, was formulated using the components shown in Table 6:

TABLE 6

| Component | Percent |
|---|---|
| HET crude glycerin | 42.00% |
| Water | 33.92% |
| Diethanolisopropanolamine | 24.00% |
| Potassium hydroxide | 0.08% |

The foregoing example and embodiments were present for illustrative purposes only and not intended to limit the scope of the invention.

We claim:

1. A method for grinding particles, comprising:
(A) introducing a grinding additive composition into a plurality of particles to be ground to finer particle size in a ball mill or roller mill, the particles chosen from cement, clinker, calcite, limestone, aragonite, sea shells, marl, limonite, clay, shale, sand, bauxite, blast furnace slag, fly ash, natural pozzolan, calcium sulfate, or mixtures thereof;
(B) the grinding additive composition comprising a crude glycerin byproduct obtained using a heterogeneous catalytic process during biodiesel fuel production, the crude glycerin byproduct comprising: (i) 1,2,3-propanetriol in an amount of 50-99 percent; (ii) at least one glycerol ether in an amount of 5-50 percent; and (iii) chloride salt, ash, fatty acid, and fatty acid ester in an amount of 0-1 percent, the foregoing percentages based on total weight of the crude glycerin generated by the heterogeneous catalytic process; and
(C) grinding together the grinding additive composition and plurality of particles in the ball mill or roller mill, whereby the particles are ground to finer particle size.

2. The method of claim 1 wherein the at least one glycerol ether is chosen from methoxypropanediol, ethoxypropanediol, propoxypropanediol, butoxypropanediol, or a mixture thereof.

3. The method of claim 2 wherein the at least one glycerol ether is a methoxypropanediol chosen from 3-methoxy-1,2-propanediol, 2-methoxy-1,3-propanediol, or mixture thereof.

4. The method of claim 3 wherein at least one glycerol ether comprises a mixture of 3-methoxy-1,2-propanediol and 2-methoxy-1,3-propanediol in a weight ratio of 6:1 to 3:1.

5. The method of claim 2 wherein the crude glycerin contains methoxypropanediol in an amount of 10%-30% by weight based on total weight of crude glycerin obtained using heterogeneous catalyst process.

6. The method of claim 1 wherein the particles are ground with a crude glycerin obtained using heterogeneous catalyst process wherein the crude glycerin contains zero to less than 0.5% fatty acids, fatty acid esters, or oil, based on total weight of the crude glycerin,

7. The method of claim 1 wherein the additive composition further water.

8. The method of claim 1 wherein the additive composition also comprises at least one cement additive selected from the group consisting of triethanolamine, triisopropanolamine, diethanolisopropanolamine, tetrahydroxy-ethylthylene diamine, ethanoldiisopropanolamine, diethanolamine, methoxy-diethanolamine, ethoxylated methoxydiethanolamine, a glycol, crude glycerin from a homogeneous catalyzed process, an acetic acid or salt thereof, or mixtures thereof.

9. The method of claim 1 wherein the additive composition further comprises N-(2-hydroxyethyl)iminodiacetic acid (EDG), N-(2-hydroxypropyl)-iminodiacetic acid (IPDG) or salts or mixtures thereof.

10. The method of claim 1 wherein the additive composition has a pH greater than 8.0.

11. The method of claim 8 wherein the weight ratio of the at least one cement additive to the crude glycerin byproduct from the manufacture of biodiesel using a heterogeneous catalyzed process is 90:10 to 10:90 (total dry weight).

12. The method of claim 1 wherein the additive composition is combined with cement clinker particles at a dosage of 0.01% to 0.1% based on total weight.

13. An additive composition for grinding particles comprising: crude glycerin byproduct obtained from biodiesel production using a heterogeneous catalytic process, the crude glycerin byproduct comprising: (i) 1,2,3-propanetriol in an amount of 50-99 percent; (ii) at least one glycerol ether in an amount of 5-50 percent; and (iii) chloride salt, ash, fatty acid, and fatty acid ester in an amount of 0-1 percent, the foregoing percentages based on total weight of the crude glycerin generated by the heterogeneous catalytic process.

14. An additive composition of claim 13 wherein the at least one glycerol ether is chosen from methoxypropanediol, ethoxypropanediol, butoxypropanediol, or a mixture thereof.

15. An additive composition of claim 14 wherein the at least one glycerol ether is a methoxypropanediol chosen from 3-methoxy-1,2-propanediol, 2-methoxy-1,3-propanediol, or mixture thereof.

16. The composition of claim 15 wherein 3-methoxy-1,2-propanediol and 2-methoxy-1,3-propanediol are present in a weight ratio of 6:1 to 3:1.

17. The composition of claim 14 wherein the crude glycerin comprises a methoxypropanediol.

18. The composition of claim 13 where the additive composition comprises a crude glycerin obtained through heterogeneous catalyst process which contains fatty acids, fatty acid esters, or oil in an amount of zero to less than 0.5% based on total weight of the crude glycerin.

19. The composition of claim 13 wherein the additive composition further comprises water.

20. The composition of claim 13 wherein the additive composition also comprises at least one cement additive selected from the group consisting of triethanolamine, triisopropanolamine, diethanolisopropanolamine, tetrahydro-xyethylthylene diamine, ethanoldiisopropanolamine, diethanolamine, methoxy-diethanolamine, ethoxylated methoxydiethanolamine, a glycol, crude glycerin from a homogeneous catalyzed process, an acetic acid or salt thereof, or mixtures thereof.

21. The composition of claim 13 wherein the additive composition further comprises N-(2-hydroxyethyl)iminodiacetic acid (EDG), N-(2-hydroxypropyl)-iminodiacetic acid (IPDG), or a salt or mixture thereof.

22. The composition of claim 13 wherein pH is greater than 8.0.

23. The composition of claim 13 wherein the ratio of the one or more grinding additives to the crude glycerin byproduct from the manufacture of biodiesel with a heterogeneous catalyzed process is 90:10 to 10:90.
